(19) United States
(12) Patent Application Publication
(10) Pub. No.: US 2007/0075133 A1
(43) Pub. Date: Apr. 5, 2007

(54) Method, System and Computer-Readable Medium for Radio Frequency Identification Device

(75) Inventor: C. Douglas Yeager, Knoxville, TN (US)

Correspondence Address: HAYNES AND BOONE, LLP, 901 MAIN STREET, SUITE 3100, DALLAS, TX, 75202, US

(73) Assignee: SIRIT TECHNOLOGIES, INC., Toronto, ON (CA)

(21) Appl. No.: 11/464,440

(22) Filed: Aug. 14, 2006

Related U.S. Application Data
(60) Provisional application No. 60/708,165, filed on Aug. 15, 2005.

(51) Int. Cl. G06K 5/00

(52) U.S. Cl. 235/380

(57) ABSTRACT

A method, computer-readable medium, and system for configuring an adapter is provided. A network connection is established between an adapter host and a network server. An account associated with the adapter is accessed by the sever. Tag emulation data is transferred to the adapter host and is loaded onto the adapter. The adapter may be configured to emulate a near field communication reader-to-reader tag upon loading of the tag emulation data.

### RELATED APPLICATION DATA

This patent application claims the benefit of provisional U.S. Patent Application Ser. No. 60/708,165, filed Aug. 15, 2005.

### CROSS-REFERENCE TO RELATED APPLICATIONS

The present application is related to U.S. patent application Ser. No. 11/384,708, filed on Mar. 20, 2006, entitled “Radio Frequency Identification Device,” the disclosure of which is incorporated herein by reference.

### FIELD OF THE INVENTION

Embodiments disclosed herein relate to the field of radio frequency identification (RFID) tag readers and writers as well as near field communication (NFC) devices. More particularly, embodiments disclosed herein relate to NFC devices interfaced to personal digital assistant (PDA), personal computers, and similar devices, and mechanisms by which such devices may be used to make “contactless” payments, to exchange ticketing information, or access other applications via a network.

### BACKGROUND

Radio Frequency Identification (RFID) tags and labels are typically passive devices that have the ability to store information that may be retrieved when a RFID reader comes into close proximity with the tag or label. Specialized electronic devices have been developed to write and read information to and from RFID tags. These devices are often referred to as RFID readers or writers.

Near Field Communication (NFC) is a protocol for communication between two RFID readers that was initially developed by Sony® and Philips®. In one form of NFC, during reader to reader communication, one of the readers places itself in passive mode and the other reader is in active mode. The passive mode reader emulates an RFID tag to the active reader. This form of NFC may be referred to as an R2R (reader to reader) protocol. One advantage of this form of NFC is its compliance to the currently deployed infrastructure.

### BRIEF DESCRIPTION OF THE DRAWINGS

Aspects of the present disclosure are best understood from the following detailed description when read with the accompanying figures, in which:

FIG. 1 is a diagrammatic representation of a top and bottom view of an embodiment of an NFC R2R adapter;

FIG. 2 is a simplified diagrammatic representation of an internal view of the adapter depicted in FIG. 1;

FIG. 3 is a diagrammatic representation of an embodiment of a system in which the adapter depicted in FIGS. 1 and 2 may be deployed;

FIG. 4 is a diagrammatic representation of various exemplary applications accessible by the adapter described with reference to FIGS. 1 and 2 in the system described in FIG. 3;

FIG. 5 is a diagrammatic representation of the adapter described with reference to FIGS. 1 and 2 configured for use with non-NFC compliant contactless systems;

FIG. 6 is a diagrammatic representation of an embodiment of a communication and authentication configuration of the adapter described with reference to FIGS. 1 and 2 and a server;

FIG. 7 depicts a diagrammatic representation of an embodiment of an exemplary system with various adapters configured to communicate over the Internet with a server to receive data or tickets from ticket vendor servers or a bank account sever;

FIG. 8 depicts a flowchart of a processing routine for configuring an adapter implemented in accordance with embodiments disclosed herein; and

FIG. 9 depicts a flowchart of processing of a transaction routine when adapter is coupled with a host device in accordance with an embodiment

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Generally, NFC R2R protocols required specialized equipment devices designed specifically for those protocols. This generally limits their availability and adaptability for various purposes. What is needed, therefore, are NFC R2R devices that may be interfaced to general-purpose, commonly available electronic devices such as PDA's or personal computers.

The “Secure Digital” (SD) interface is a standard interface for personal digital assistants (PDAs) as a means of expanding the capabilities of the handheld device. Many manufacturers make SD cards for various purposes such as expansion memory, video games, or even devices like global positioning system (GPS) receivers and bar code scanners. Mini SD is another standard interface for PDAs as well as mobile phones. The Mini SD interface is very similar to the SD interface and differs only in size. More information on SD and Mini SD may be obtained at www.sdcard.org or www.sdcard.com.

The “Universal Serial Bus” USB interface is a standard interface to laptop computers and personal computers as a means of expanding the capabilities of the host device or simply moving information to another device. More information about the USB interface can be obtained at www.usb.org.

The “Bluetooth®” interface is a standard interface to laptop computer, personal computers, personal digital assistants, smart phones, and cell phones. The Bluetooth interface is not a physical connection, but a wireless one. The Bluetooth interface is designed for short range applications such as connecting a wireless keyboard or mouse to a personal computer. More information about Bluetooth can be obtained at www.bluetooth.org.

The term “NFC” is sometimes used in the field of art in a generic sense to refer to “near-field communications,” and sometimes “NFC” is used in a specific sense to refer to communication between two devices via 13.56 MHz near field technology developed by Sony and Philips and defined by such standards as ISO 14443A/B, ISO 15693, “FeliCA protocol,” and ISO 18092. A contactless “smart card” is one example of a passive device employing NFC technology. The term “R2R” was originally a trademark of the company Inside Contactless, but Inside Contactless later changed that reference to “eNFC.” The term “R2R” is now sometimes used in a generic sense referring to “reader to reader” communications and is sometimes used in a more specific sense to refer to Inside Contactless R2R (now eNFC) technology in which one RFID reader acts like, that is emulates, an RFID tag for another RFID reader. For purposes herein the term “NFC R2R” is used to refer to both generic and specific NFC and R2R data communications.

Embodiments disclosed herein relate to an RFID communicator with NFC and R2R functionality that reads and writes to radio frequency identification (RFID) tags or labels as well as emulates an RFID tag or label. The term “NFC R2R adapter” as used herein refers to a device implemented according to embodiments of the disclosure that may communicate with an NFC R2R reader or an NFC R2R writer using RFID protocols, and that may connect, e.g., removably, to a PDA, personal computer, or similar device through an interface, such as a industry standard physical or a wireless connection. For example, an NFC R2R adapter may be securely programmed with NFC R2R information by a PDA, computer, or similar device by interfacing the NFC R2R adapter to standard peripheral ports such as the secure digital (SD) port, mini SD port, universal serial bus (USB), or Bluetooth interface among others on the PDA or computer. After the NFC R2R adapter is programmed it may be used in passive mode to emulate an RFID tag to make what is called a “contactless” transaction such as a payment by passing credentials, such as bank or credit card information, pre-paid credits, or emulating a ticket for admission. This NFC R2R adapter then becomes an NFC R2R device. The NFC R2R adapter preferably has an SD, Mini SD, USB, or Bluetooth interface built into its geometry so that it connects physically or wirelessly to the corresponding interface on the PDA, PC, smart phone, pager, Blackberry®, cell phone or similar device. Since Bluetooth is a wireless technology, there is no additional form-factor geometry for a Blue Tooth interface built into an NFC R2R adapter. In preferred embodiments the NFC R2R adapter has a very small footprint so that it may be easily carried on a key ring and so it is not awkward while in use with its host. Most preferably, the NFC R2R adapter has dimensions that do not exceed 40 mm×80 mm×20 mm.

Embodiments disclosed herein provide an interface between an NFC R2R adapter and a PDA, computer, mobile phone, or other data processing system or computational device through a designed interface to load tag emulation data over the Internet and onto the NFC R2R adapter. The preferred designed interface between the NFC R2R adapter and the PDA, computer, or similar device (collectively referred to herein as a host device) is based upon a standard data exchange protocol for the PDA, computer, or similar device. For example the preferred designed interface comprises an external device port, e.g., a data storage port such as a secure digital (SD) or memory stick port, a communication port e.g., USB or Bluetooth, or a general-purpose port e.g., PC Card or compact flash (CF). In some embodiments, a custom interface specifically designed for use between a PDA, computer or similar device and the NFC R2R adapter may be employed. Once data is loaded from the PDA or computer to the NFC R2R adapter over the designed interface, the NFC R2R adapter may then be disconnected from the designed interface with the PDA or computer and used in a stand alone mode to, for example, emulate an NFC R2R adapter employing an RFID tag or label. The NFC R2R adapter may then be presented in currently deployed contactless applications such as mass transit ticketing systems, contactless pre paid stored value payments, or contactless credit card payments. In some embodiments the NFC R2R adapter may be used to emulate an NFC R2R adapter while still connected to the PDA, computer, or similar adapter. In some embodiments the NFC R2R adapter may be used while attached to a PDA or computer or similar adapter to read NFC R2R information from a passive NFC R2R adapter or to write NFC R2R information to a passive NFC R2R adapter.

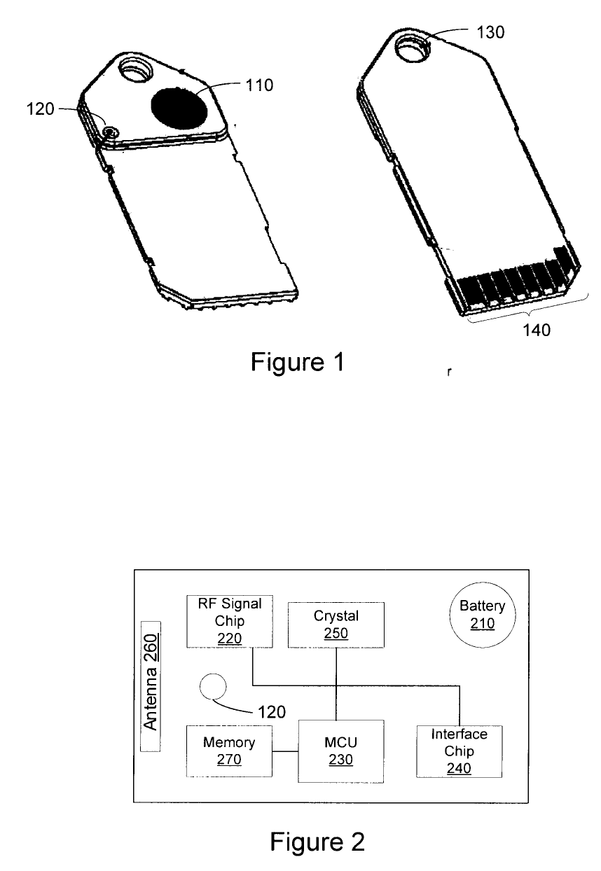

Referring to FIG. 1, the top and bottom of an embodiment of an NFC R2R adapter 100 is shown. A depressible button 110 is shown that provides a mechanism for powering on adapter 100. When adapter 100 is not interfaced to a PC, PDA, or other host device, it will typically need power to function as either an active reader or to emulate an RFID tag or label. Button 110 provides a mechanism to enable adapter's 100 functionality when it is not interfaced to a host device. Additionally, button 110 provides a security feature because the user of the adapter has the ability to physically control when the adapter is being read by other contactless readers. In one implementation, only when button 110 is depressed will adapter 100 emulate an RFID tag, and when button 110 is not depressed adapter 100 will not be recognized by any other contactless readers. An LED 120 may provide a visual indication of activity of adapter 100 and may also provide an indication of adapter's 100 battery power. A hole 130 may be disposed on adapter 100 that provides a mechanism for the user to keep the adapter on a key ring for ease of carrying. An interface 140, such as an SD interface, is additionally disposed on adapter 110 that may provide a communication interface to various devices, such as PDA's, smart phones, laptops, cell phones, PC's, or another host device. Interface 140 may be implemented as, for example, an SD interface, USB, mini SD, Bluetooth, or another suitable interface.

Referring to FIG. 2, a simplified internal view of adapter 100 is depicted. A battery 210 is used to power the adapter when it is not interfaced to its host PC or PDA. A radio frequency (RF) signal chip 220 is used to convert signals from a micro controller (MCU) 230 to an RF protocol, such as the 13.56 MHz RF protocol. The MCU 230 may communicate signals to RF signal chip 220 with an interface, such as an interface utilizing a serial peripheral interface (SPI) protocol. MCU 230 also communicates signals to an interface chip 240, or controller chip, such as an SDIO controller chip. Interface chip 240 handles communication signals to the SD interface and may be used for either the SD or mini SD interface. Other interface chips may be suitably substituted for interface chip 240 to provide for different interfaces. A crystal 250, such as a 13.56 MHz crystal, may be used to run RF signal chip 220, MCU 230, and interface chip 240. An antenna 250 may be built into the circuit board of adapter 100. In one implementation, antenna 250 may be implemented as a loop to loop coil antenna. A memory 270 may be interfaced with MCU 230.

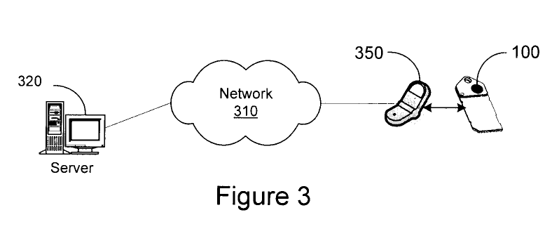

FIG. 3 is a diagrammatic representation of a system 300 in which adapter 100 may be deployed. System 300 comprises a network of data processing systems in which embodiments disclosed herein may be implemented. Network system 300 contains a network 310, which is the medium used to provide communications links between various devices and computers connected together within network system 300. Network 310 may include connections, such as wire, wireless communication links, fiber optic cables, or other suitable communication infrastructure.

In the depicted example, a server 320 is connected to network 310. In addition, a host 350 device may connect to network 310. Host 350 may be, for example, a PDA, a mobile phone, a lap top, or other data processing system. Network system 300 may include additional servers, clients, and other devices not shown. In a particular implementation, network system 300 comprises the Internet with network 310 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network system 300 also may be implemented as a number of different types of networks, such as for example, an intranet, a local area network (LAN), or a wide area network (WAN), and FIG. 3 is intended as an example, and not as an architectural limitation.

In order to load information onto adapter 100, adapter 100 is connected through its interface, e.g., an SD, mini SD, USB, Blue Tooth, or other suitable interface, to its host 350 device, e.g., a PDA, PC, cell phone, smart phone, or other data processing system. Host 350 may then connect to network 310, such as the Internet, through any number of standard Internet connections. The Internet connection may be made over any of a variety of interfaces, such as the Global System for Mobile Communications (GSM), code division multiple access (CDMA), or other mobile phone connections, via a digital subscriber line (DSL), cable modem, dial up, or other suitable connection. Adapter 100 may then exchange information with server 320 while host 350 is connected to network 310. For example, server 320 may exchange information for account verification and authentication purposes, updating account information, and for providing tag emulation data onto adapter 100.

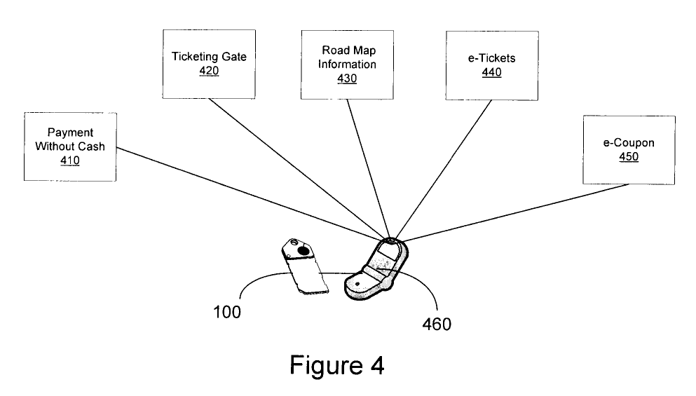

FIG. 4 illustrates various exemplary applications adapter 100 may access in system 300 in accordance with embodiments disclosed herein. In the illustrative example, applications accessible by adapter 100 may include a payment without cash application 410 accessed by adapter 100 emulating an NFC R2R device such as a MasterCard PayPass, a ticketing gate application 420 accessed by adapter 100 emulating an NFC R2R device, a road map information application 430 accessed via adapter 100 operating as a standard RFID reader, an e-tickets application 440, e.g., for retrieval or verification of air travel tickets, and an e-coupon application 450 accessed by adapter 100 operating as a standard RFID reader. In the illustrative example, applications 410-450 may be accessible by adapter 100 through host 350 connected with the Internet, and applications 410-450 may be provided by a server, such as server 320 depicted in FIG. 3.

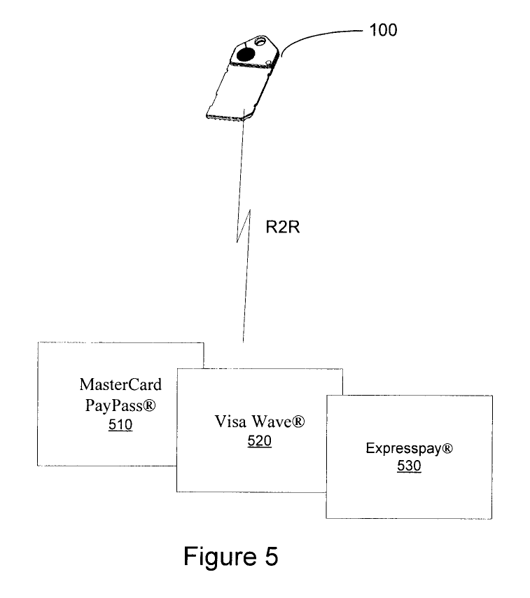

FIG. 5 is a diagrammatic representation of adapter 100 configured for use with non-NFC compliant contactless systems that are already deployed. Many currently available systems and services were built and deployed without NFC capabilities. Because adapter 100 supports R2R, which provides the ability to emulate a tag, adapter 100 may be deployed for use in existing non-NFC compliant systems, such as the MasterCard PayPass® system 510, Visa Wave® system 520, American Express Expresspay® 530, and entering mass transit terminals that currently support RFID fare passes.

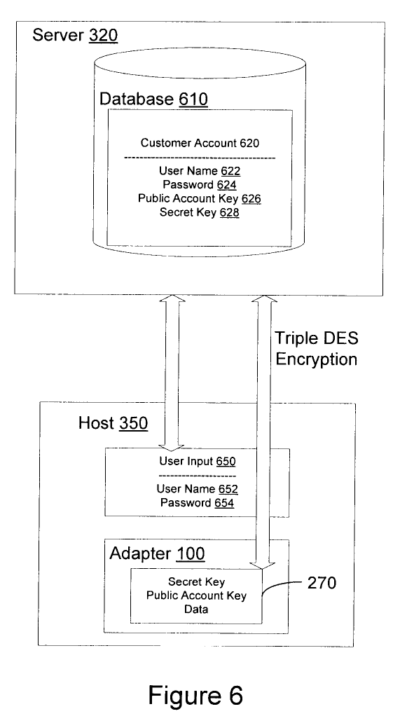

FIG. 6 is a diagrammatic illustration of a communication and authentication configuration 600 for adapter 100 with a server, such as server 320 depicted in FIG. 3. Server 320 may include or interface with a database 610 that contains information of a user of adapter 100 as well as adapter 100 registered to the user. Database 610 may include information about a user account 620, such as a customer username 622, password 624, account number 626, or public account key, and secret key 628. Public account number 626 may be a number that is transferred from adapter 100 with any transaction to another reader. In one implementation, account number 626 may be hard programmed and locked onto adapter 100. Secret key 628 may be randomly chosen by server 320 and matches the secret key that is stored on adapter 100. During communication, e.g., Triple DES Encryption Over the Internet, between server 320 and adapter 100, server 320 may have the ability to change secret key 628 that is shared between adapter 100 and server 320. While triple DES encryption is depicted, other suitable forms of encryption or communication security techniques may be suitably substituted therefor. The secret key of any adapter is kept confidential and not known by any party except the server and adapter, and thus the secret key is shared only between server 320 and adapter 100. Host 350, such as a PDA, PC, cell phone, or smart phone, may include an input mechanism, such as a keypad, touch screen, or the like, by which user input 650 including a username 652 and password 654 may be supplied to host 350 and securely transferred to server 320 as a means of authenticating and accessing portions of the user's account 620. This secure authentication may be standard secure socket layer (SSL) protocol that is commonly used in Internet transactions. Once the user has authenticated and gained access to account 620, the user may be able to perform transactions through host 350, such as purchasing mass transit tickets, movie tickets, sports tickets, money transfers, update pre-pay values, transfer credit card information, transfer coupon information to account 620, or the like. Once the user has modified account 620, the account data may be compiled into a message or dataset that is ready to transfer to adapter 100.

Adapter 100 that is interfaced with host 350 may include a memory 270. In other implementations, memory 270 may be implemented in host 350. In memory 270, public account key, shared key, and other data may be stored. Information such as a message or dataset may be securely transferred onto adapter 100 as well as the data on adapter 100 transferred to server 320 through encrypted communications. Because only the server 320 and adapter 100 know the shared key of the user's account, a symmetric encryption algorithm such as DES or triple DES may be performed on the data communication between server 320 and adapter 100 and safely pass it through host 350 as well as any other computers in the network path without being compromised. After each transaction between server 320 and adapter 100, server 320 may change the secret key of the account and notify, through the encrypted communication, adapter 100 to update its secret key with the new one. This will ensure that no transactions between server 320 and adapter 100 are duplicated or emulated by another server.

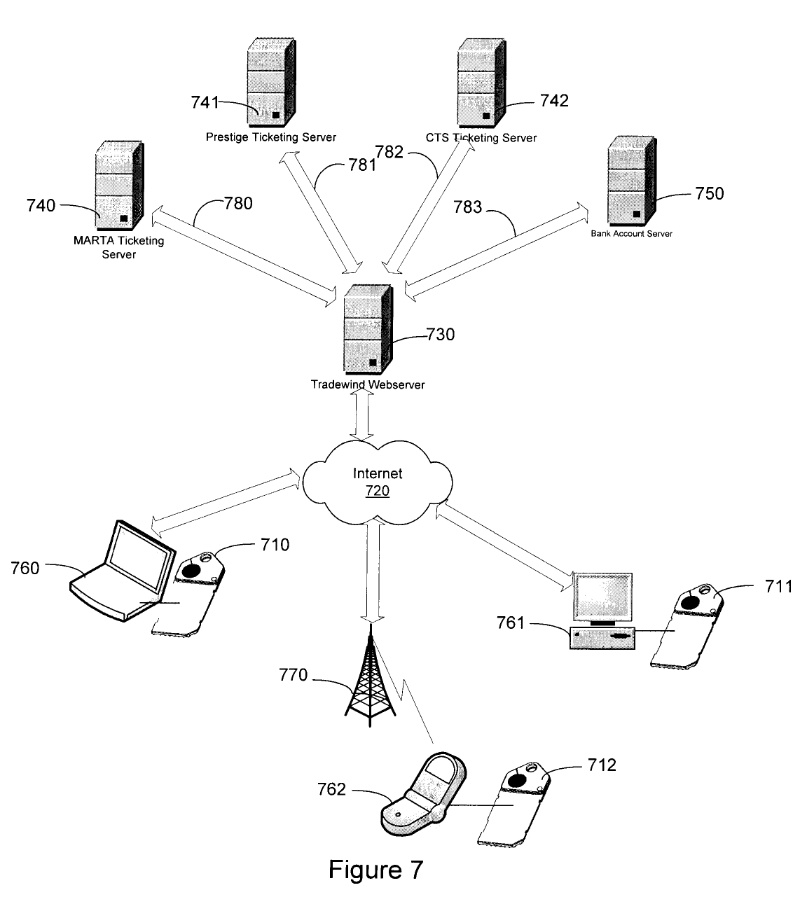

FIG. 7 depicts a diagrammatic representation of a system 700 with various adapters 710-712 configured to communicate over the Internet 720 with a server 730 (illustratively designated “TradeWind Webserver”) to receive data or tickets from ticket vendor servers 740-742 or a bank account sever 750. Server 730 is an example of server 320 and may facilitate user account management. Adapters 710-712 may be configured similar to adapter 100 as described above. Each of adapters 710-712 is connected with a respective host 760-762. In the illustrative example, host 760 comprises a laptop computer and is coupled with adapter 710 via a USB, host 761 comprises a personal computer coupled with adapter 711 via a Bluetooth connection, and host 762 comprises a PDA or mobile phone coupled with adapter 712. Hosts 760-761 may directly connect with Internet 720, and host 762 may connect with Internet 720 via a cell tower 770 and other telecommunication infrastructure. Server 730 may provide an interface to various vender servers 740-742 and 750. Server 730 provides for secure transactions with third party companies operating servers 740-742 and 750 that may provide product services, such as ticket sales, credits, coupons, or monetary services to the user accounts on, or managed by, server 730. Thus, server 730 facilitates authentication of adapter 100 that allows for transactions to be made by adapter 100 in stand-alone mode or via a suitable host interfaced therewith.

In the illustrative example, server 740 comprises a ticketing server (illustratively designated “MARTA Ticketing Server”) that may provide mass transit system services. MARTA Ticketing Server is deployed, for example, in Atlanta Georgia and uses MiFare Ultralight RFID tags as single trip tickets to board trains. Server 741 (illustratively designated “Prestige Ticketing Server”) comprises a mass transit system deployed in London England that uses MiFare RFID tags as single trip tickets, monthly passes, and pre-paid cards to board trains. Server 742 (illustratively designated “CTS Ticketing Server”) may comprises a Cubic Transportation Systems (CTS) that manages many mass transit fare operations for different cities. Other services that may be deployed in system 700 include financial service servers, such as server 750 (illatively designated “Bank Account Server”), credits, e-coupons, as well as movie tickets services for companies such as Regal Cinemas and Fandango, sports tickets for National Football League (NFL) or other sporting events, and credits for refreshments at these events. A virtual private network (VPN) tunnel 780-783 is depicted as the communication link between server 730 and third party providers having servers 740-742 and 750 deployed in system 700, but alternative secure communications mechanisms may be suitably substituted therefor.

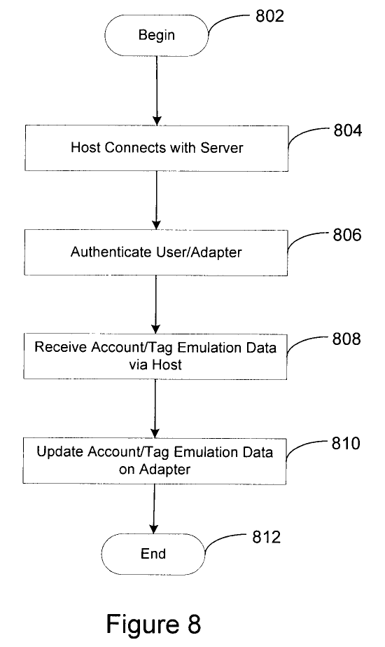

FIG. 8 depicts a flowchart of a processing routine for configuring an adapter implemented in accordance with embodiments disclosed herein. The processing routine is invoked (step 802), and a connection with a suitable server may be established (step 804). The server connection may be established by the host, such as a PDA, cell phone, laptop computer, personal computer, or other suitable data processing system adapted to provide network communications. An authentication procedure may be performed between the adapter and server over the network connection via communication transfers provided by the host on behalf of the adapter (step 806). Assuming the authentication procedure is successful, account information and/or tag emulation data may be transferred from the server to the host (step 808), e.g., over an Internet session established between the host and server. Account information and/or tag emulation data may then be updated on the adapter (step 810), e.g., via writes performed by the host to the adapter over the interface, such as an SD interface, MiniSD interface, PCMCIA interface, CF interface, USB interface, or another interface that provides a communication coupling between the adapter and the host. The processing routine cycle may then end (step 812). The adapter may then be used in conjunction with the connected host, e.g., to read information from a passive NFC R2R adapter or write information thereto. The adapter may additionally be used for supplying user credentials for executing a transaction over a network via a host device having network communication capabilities. The adapter may be disconnected from the host and used in a stand-alone mode in which the adapter may emulate an NFC R2R adapter and thus may be deployed in a contactless transaction system.

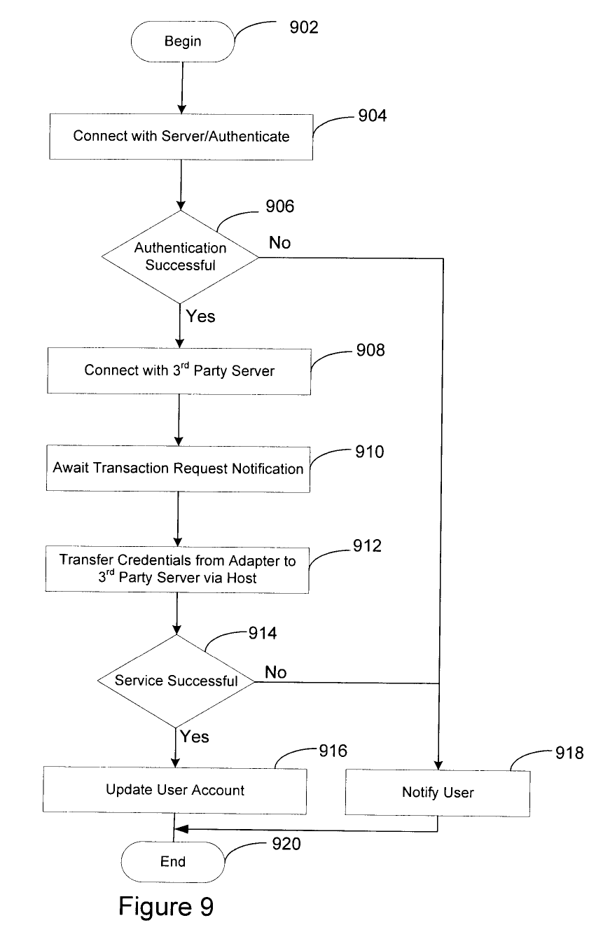

FIG. 9 depicts a flowchart of processing of a transaction routine when adapter 100 is coupled with a host device in accordance with an embodiment. The transaction routine is invoked (step 902), and the adapter may connect with a server that provides authentication and/or account management services (step 904), e.g., server 830 depicted in FIG. 3. An evaluation may be made to determine if the authentication was successful (step 906). In the event that the authentication fails, the user may optionally be notified (step 918), and the transaction routine processing cycle may then end (step 920). In the event that the authentication is successful, the user may navigate the host device to a desired service, e.g., to one of servers 840-842 and 850 depicted in FIG. 8 (step 908). The host device may await notification of a transaction request (step 910), and on receipt thereof may receive transaction data and/or credential information from adapter 100, and the transaction data and credentials may be transferred to the server with which the host is connected (step 912). An evaluation may be made to determine if the transaction was successful (step 914). In the event that the service did not successfully complete, the user may optionally be notified according to step 918. In the event that the transaction was successful, the user account may then be updated accordingly (step 916), e.g., by deducting the transaction amount. The account update may be made by a communication detailing the transaction that is supplied to the account management server, such as server 830 depicted in FIG. 8, and/or by a communication detailing the transaction that is supplied to adapter 100. The transaction routine cycle may then end according to step 920.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of configuring an adapter, comprising:
establishing a network connection between an adapter host and a network server;
accessing, by the server, an account associated with the adapter;
transferring tag emulation data to the adapter host; and
loading the tag emulation data onto the adapter, wherein the adapter is configured to emulate a near field communication reader-to-reader tag upon loading of the tag emulation data.

2. The method of claim 1, wherein transferring tag emulation data further includes transferring user account information necessary for executing financial transactions between the adapter and a contactless transaction system.

3. The method of claim 1, wherein loading the tag emulation data further comprises transferring the tag emulation data to the adapter via an interface coupling between the adapter and the adapter host.

4. The method of claim 3, wherein the interface comprises one of a Secure Digital interface, a Universal Serial Bus interface, a Mini Secure Digital interface, and a Bluetooth interface.

5. The method of claim 1, wherein establishing a network connection comprises establishing an Internet session.

6. The method of claim 1, wherein the adapter host comprises one of a personal computer, a laptop computer, a personal digital assistant, and a cell phone.

7. The method of claim 1, wherein transferring tag emulation data further comprises transferring the tag emulation data over a secure channel established between the server and the adapter host.

8. A computer-readable medium having computer-executable instructions for execution by a processing system, the computer-executable instructions for configuring an adapter, comprising:
instructions that establish a network connection between an adapter host and a network server;
instructions that access, by the server, an account associated with the adapter;
instructions that transfer tag emulation data to the adapter host; and
instructions that load the tag emulation data onto the adapter, wherein the adapter is configured to emulate a near field communication reader-to-reader tag upon loading of the tag emulation data.

9. The computer-readable medium of claim 8, wherein the instructions that transfer the tag emulation data further include instructions that transfer user account information necessary for executing financial transactions between the adapter and a contactless transaction system.

10. The computer-readable medium of claim 8, wherein the instructions that load the tag emulation data further comprise instructions that transfer the tag emulation data to the adapter via an interface coupling between the adapter and the adapter host.

11. The computer-readable medium of claim 10, wherein the interface comprises one of a Secure Digital interface, a Universal Serial Bus interface, a Mini Secure Digital interface, and a Bluetooth interface.

12. The computer-readable medium of claim 8, wherein the instructions that establish a network connection comprise instructions that establish an Internet session.

13. The computer-readable medium of claim 8, wherein the adapter host comprises one of a personal computer, a laptop computer, a personal digital assistant, and a cell phone.

14. The computer-readable medium of claim 8, wherein the instructions that transfer tag emulation data further comprise instructions that transfer the tag emulation data over a secure channel established between the server and the adapter host.

15. A system for configuring an adapter, comprising:
a communication network;
a server deployed in the communication network;
an adapter host adapted to communicatively couple with the communication network; and
an adapter adapted to couple with the adapter host, wherein the adapter host establishes a network connection with the server and receives tag emulation data therefrom, and wherein the adapter host loads the tag emulation data onto the adapter, and wherein the adapter is configured to emulate a near field communication reader-to-reader tag upon loading of the tag emulation data.

16. The system of claim 15, wherein user account information necessary for executing financial transactions in a contactless transaction system is transferred from the server to the adapter host.

17. The system of claim 15, wherein the tag emulation data is loaded on the adapter via an interface coupling between the adapter and the adapter host.

18. The system of claim 17, wherein the interface comprises one of a Secure Digital interface, a Universal Serial Bus interface, a Mini Secure Digital interface, and a Bluetooth interface.

19. The system of claim 15, wherein the network comprises the Internet.

20. The system of claim 15, wherein the adapter host comprises one of a personal computer, a laptop computer, a personal digital assistant, and a cell phone.
